(19) United States
(12) Patent Application Publication
(10) Pub. No.: US 2017/0103506 A1
(43) Pub. Date: Apr. 13, 2017

(54) COMPONENT HEALTH MONITORING SYSTEM USING COMPUTER VISION

(71) Applicant: Caterpillar Inc., Peoria, IL (US)

(72) Inventors: Venkata Bhagavathi DANDIBHOTLA, Peoria, IL (US); Aloke Jude MASCARENHAS, Peoria, IL (US); Maria Cristina HERRERA DE KONTZ, Chillicothe, IL (US)

(73) Assignee: Caterpillar Inc., Peoria, IL (US)

(21) Appl. No.: 14/879,810

(22) Filed: Oct. 9, 2015

(51) Int. Cl. G06T 7/00; H04N 7/18; E02F 9/26; G06K 9/62

(52) U.S. Cl. CPC G06T 7/001; G06T 7/0008; G06K 9/6256; G06K 9/6212; H04N 7/183; G06K 9/6277; E02F 9/268; G06T 2207/20072; G06T 2207/20081; G06T 2207/10152; G06T 2207/30164; E02F 3/34

(57) ABSTRACT

A component health monitoring system may include an optical system configured to irradiate an area containing a work implement and including a surface of a component to be inspected in a position mounted on the work implement, and a sensor configured to capture a target image of the area. An image processor may receive the target image from the sensor and analyze the target image, determine a first feature set including directional changes in image intensity for the target image, retrieve a reference image from a memory, and determine a second feature set for the reference image. The image processor may also build and train a model for use by a classifier that segregates feature sets determined from a plurality of target images into a first classification that includes features that characterize a portion of an image including the component with dimensions that fall within acceptable thresholds, and a second classification. A notification module notifies an operator of the machine when the image processor classifies a new target image as falling within the second classification.

### TECHNICAL FIELD

The present disclosure relates generally to a component monitoring system and, more particularly, to a component health monitoring system using computer vision.

### BACKGROUND

Machines, for example mining shovels, motor graders, dozers, wheel loaders, and excavators are commonly used in material moving applications. These machines include a ground engaging tool (GET) having a cutting edge configured to contact the material. During use of the cutting edge, the material abrades the cutting edge, causing it to erode away. On some occasions individual GET's may break off or otherwise come completely detached from a work implement on a machine, and if introduced into crushers or other equipment used to process the material, may cause considerable damage and down time. The GET is sometimes removably attached to the work implement and replaced on a periodic basis, or when damage to the GET is observed by a machine operator.

The cutting edge or the GET itself is replaced when it is determined that it has eroded beyond an acceptable limit. To make this determination, a service technician is typically called out to the machine and measures a length of the cutting edge using a measuring tape. The measured length is then compared to the acceptable limit, and selectively replaced based on the comparison. This process of determining when to replace the cutting edge and/or tool can be labor intensive and inaccurate.

An alternative way to measure erosion of a tool is described in U.S. Patent Publication 2006/0243839 of Barscevicius et al. that published on Nov. 2, 2006 (“the '839 publication”). Specifically, the '839 publication discloses using an imbedded sensor to measure erosion of wearing parts of a crusher. The sensor includes a network of resistors that wear away from the network, as the sensor is worn along with the erosion of the wearing parts being monitored. With the erosion of the wearing parts (and the resistors), the overall resistance of the sensor changes. Signals associated with the changing resistance are then delivered to a crusher setting control system for use in setting control parameters of the crusher.

Although the wear sensor of the '839 publication may offer a way to monitor erosion of a wear part, it may be less than optimal. In particular, the sensor may require the resistors to be embedded within the wear parts during fabrication of the wear parts. In some applications, the fabrication process may be too harsh for the resistors and cause the sensor to fail. In addition, the sensor is damaged during use of the crusher, thereby inhibiting the sensor from being reused. Further, the network of resistors may require the supply of significant power to the sensor. This large amount of power may require a hard-wired connection to the sensor, which may inhibit use of the sensor in some applications. Further, the signals generated by the network of resistors may change in a step-wise manner as individual resistors are removed from the network, thereby limiting accuracy in the signals generated by the sensor.

The component health monitoring system of the present disclosure addresses one or more of the needs set forth above and/or other problems of the prior art.

### SUMMARY

In one aspect, the present disclosure is directed to a component health monitoring system for use with a machine. The component health monitoring system may include an optical system configured to irradiate an area containing a work implement and including a surface of a component to be inspected in a position mounted on the work implement, a sensor configured to capture a target image of the area, and an image processor configured to receive the target image from the sensor and analyze the target image. The image processor may be further configured to determine a first feature set for the target image, and retrieve a reference image from a memory. The reference image may include at least one of an image of the work implement with the component mounted on the work implement and having dimensions that fall within acceptable thresholds, an image of the work implement with one or more of the component missing from the work implement, and an image of the work implement with the component mounted on the work implement and having dimensions that fall outside of acceptable thresholds. The image processor may also determine a second feature set for the reference image. The image processor may determine the first and second feature sets by determining a directional change in image intensity for one or more localized cells that each contain a plurality of pixels of the respective image, and build and train a model for use by a classifier that segregates feature sets determined from a plurality of target images into a first classification that includes features that characterize a portion of an image including the component with dimensions that fall within acceptable thresholds, and a second classification that includes features that characterize one of a portion of the image including the component with dimensions that fall outside of the acceptable thresholds, or the component missing entirely from the portion of the image. The component health monitoring system may also include a notification module that notifies an operator of the machine when the image processor classifies a new target image as falling within the second classification.

In another aspect, the present disclosure is directed to a method for monitoring the health of a component mounted on a work implement. The method may include capturing target images of the work implement using an optical system and one or more sensors, and retrieving from a memory reference images of the work implement with one or more of the component having a position on the implement and dimensions within acceptable threshold values. The method may further include processing the target images and the reference images to determine directional changes in image intensity as feature sets extracted from the images. The method may also include building and training a model of expected feature sets for target images including one or more of the component having a position on the work implement and dimensions within acceptable thresholds, and classifying the target images by comparison of feature sets for the images to the model. The method may still further include notifying an operator of the machine when a target image does not fall within a desired classification.

In another aspect, the present disclosure is directed to a computer-readable medium for use in a component health monitoring system to monitor the health of a component mounted on a work implement, the computer-readable medium comprising computer-executable instructions for performing a method with at least one image processor, wherein the method comprises capturing target images of the work implement using an optical system and one or more sensors, and retrieving from a memory reference images of the work implement with one or more of the component having a position on the implement and dimensions within acceptable threshold values. The method may further include processing the target images and the reference images to determine directional changes in image intensity as feature sets extracted from the images. The method may also include building and training a model of expected feature sets for target images including one or more of the component having a position on the work implement and dimensions within acceptable thresholds, and classifying the target images by comparison of feature sets for the images to the model. The method may still further include notifying an operator of the machine when a target image does not fall within a desired classification.

### BRIEF DESCRIPTION OF THE DRAWINGS

FIG. 1 is an isometric illustration of an exemplary disclosed machine; and

FIG. 2 is a flow chart of an exemplary component health monitoring process that may be performed in conjunction with the machine of FIG. 1.

### DETAILED DESCRIPTION

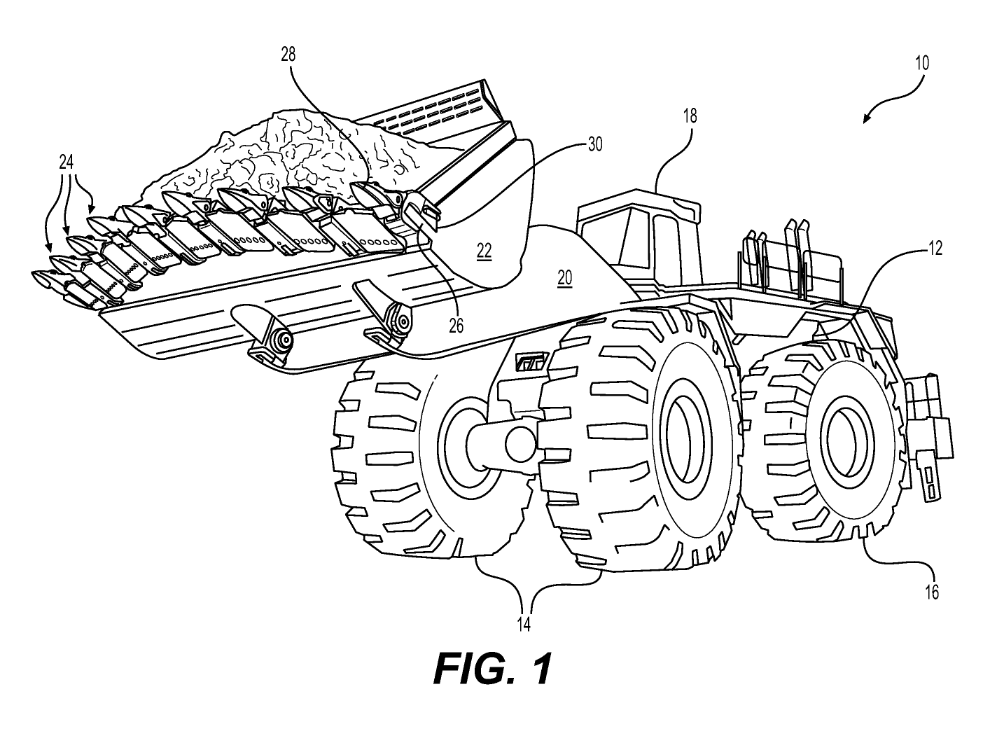

An exemplary embodiment of a machine 10 is illustrated in FIG. 1. Machine 10 may be, for example, a mining shovel, a wheel loader, a track loader, a backhoe, a hydraulic excavator, or any other type of machine known in the art. As a wheel loader, machine 10 may include a chassis 12 supported by a pair of front wheels 14 and a pair of rear wheels 16 (only one of which is shown). At least the front wheels 14 may be steerable, and chassis 12 may include front and rear frame portions that may be capable of relative articulation. Machine 10 may include an on-board operator station 18, which may provide accommodations for an operator and also may house control equipment that enables machine 10 to be operated remotely.

A lift linkage mechanism 20 may extend from the chassis 12, and may be capable of pivotal movement vertically adjacent its proximal end relative to chassis 12. A work implement 22, such as a scoop or bucket, may be attached adjacent the distal end of lift linkage mechanism 20, and may be capable of pivotal movement relative to lift linkage mechanism 20. Other types of lift linkage mechanisms and work implements capable of various movements are contemplated, depending on the type of machine and the type of work to be performed.

Work implement 22 may be equipped with one or more ground engaging tools (GET) 24 located at or adjacent to a cutting edge 26. For example, the disclosed bucket is illustrated as being provided with a plurality of similar tooth assemblies that are spaced apart along the length of cutting edge 26. GET 24 may be a single-piece component or a multi-piece component, e.g., a multi-piece tooth assembly that may be removably connected to work implement 22. In some embodiments, GET 24 may be a two-piece component having a wear tip 28 and an adapter 30 that are connected to cutting edge 26 of work implement 22 via a retention system, which may allow GET 24 to be removably connected to work implement 22. Details of the retention system are not described since numerous retention systems are known and any number of known retention systems could be employed. Wear tip 28 may be joined to a nose end of adapter 30 in any manner known in the art, for example via welding, threaded fastening, or by a releasable retention system allowing for removal of wear tip 28 from adapter 30 and replacement with a new wear tip when necessary or desirable.

GET 24 may engage a material to be removed or excavated, and such engagement may cause GET 24 to wear away or become completely disengaged and lost during use of machine 10. After a surface of GET 24 has worn by a predetermined threshold amount, or GET 24 has fallen off of a work implement of the machine, GET 24 should be replaced to help ensure productivity and/or efficiency of machine 10, and to avoid any damage that may be caused by GET 24 entering further processing operations intended for the materials being removed or excavated. GET 24 may be of a size and weight consistent with the size of machine 10 on which it may be mounted. For example, an exemplary GET 24 may include a lifting eye or other feature when GET 24 is large enough and heavy enough to require heavy equipment to manipulate it during mounting on and removal from work implement 22. Such massive GET components mounted on a large machine in highly abrasive environments experience rapid topographic wear.

An optical system may be mounted on machine 10 in a position that provides an unobstructed line-of-sight from one or more cameras or other optical devices to an area encompassing one or more GET 24 connected along the cutting edge 26 of work implement 22 on machine 10. In some implementations the optical system may be mounted on a portion of machine 10, such as in a position high on operator station 18. In other implementations one or more cameras or other optical devices providing images of a work implement with one or more GET 24 on a first machine may be mounted on one or more other machines, or offboard the machines at temporary or permanent imaging stations. Images captured by optical devices may be transmitted to an image processor that is part of a component health monitoring system onboard the first machine, or offboard the first machine at a back office or other location including one or more processors configured to perform image processing in accordance with various disclosed embodiments. The devices employed for capturing target images of the work implement and GET's may include one or more infrared cameras or other devices that capture images in wavelengths of radiation outside of the visible wavelengths of light. In various implementations, the optical system may be configured to irradiate the work implement and GET's with visible light, infrared light, gamma radiation, X-rays, or any other form of electromagnetic radiation. In addition or alternatively, the system may include ultra-sonic devices configured to irradiate the work implement 22 and GET 24 with sound waves. This may allow the component health monitoring system in accordance with various implementations of this disclosure to operate under a variety of environmental conditions and at times of day when visible light images may not provide a level of resolution sufficient to allow for accurate characterization of the component health.

A component health monitoring system in accordance with various implementations of this disclosure may represent a computing system associated with any entity that makes available to an operator of a machine notifications of the health of components such as GET 24 mounted on implements, such as work implement 22, as well as other related services. That entity, for instance, might be a job site foreman responsible for monitoring the health of the machines operating at a particular job site, a dealer that sells machine 10 to a user, a lessor that leases machine 10 to a user, a manufacturer of parts such as GET 24 for machine 10, or a seller of parts for machine 10. In other embodiments, that entity may be an insurance provider for machine 10 or a user, a warranty servicer for machine 10, a lien holder to machine 10, or another third party having some relationship to machine 10 or a user or operator. As explained below in more detail, the component health monitoring system may have any number or combination of computing elements enabling it to communicate, store, and process data to carry out the disclosed techniques. For example, the component health monitoring system may embody a server computer or a collection of server computers configured to perform the described techniques.

The component health monitoring system may interact and communicate with other elements, such as a mobile device used by an operator or other personnel to process a captured digital image of a component of machine 10 and determine wear of the component. Depending upon the embodiment, a component health monitoring system may also perform other parts-related services, such as notifying a dealer system when it is determined that a part of machine 10 is sufficiently worn, so that the dealer may take action if warranted.

The component health monitoring system may include one or more computing systems that each have different roles, perform different functions, or assume different degrees of involvement in carrying out the disclosed techniques. For example, some functions of the system may be performed offboard the machine in a “server-based” environment or a “cloud” environment that performs the disclosed component-health-monitoring techniques as part of a service over a network. In such a server or cloud environment, an offboard image processing system (i.e., the server or “cloud”), for example, may receive digital images of components from one or more mobile devices over a wired or wireless network. The offboard image processing system may then process the images to determine the health of the components, and return results to the one or more mobile devices over the network. Thus, in a server or cloud environment, the more resource intensive and complicated computations associated with processing the images may be performed in the server or cloud environment, while a relatively simple mobile device may operate as a lightweight portal (e.g., application or browser) that allows an operator to access the image processing system over a network. Alternatively, the image processing may be performed in a “client-side” environment in which a mobile device performs the bulk of the processing locally.

A mobile device used by a machine operator or other personnel, or a computing system onboard the machine may include software applications (e.g., “apps”), including one or more applications used by the component health monitoring system for image capture, image processing, and notification of the health of one or more components mounted on the machine. The computing system may have any number or combination of computing elements or modules enabling it to communicate, store, and process data to carry out the disclosed techniques. The various computing systems onboard the machine, on a mobile device, or at an offboard, wayside, or back office location may communicate with each other over wired or wireless networks. The networks may represent any type or combination of electronic communication network(s) configured to communicate data between nodes connected to the network. For example, networks configured to communicatively couple the various computing systems of the component health monitoring system may include the Internet, an Ethernet, a local area network (LAN), a wide area network (WAN), a personal area network (PAN), cellular network, a public switched telephone network (PSTN), or any combination thereof. In some embodiments, a network may include a mobile network and related infrastructure operable to provide Internet connectivity to a mobile device, such as a 2^{nd} Generation (2G) cellular communication network, a 3^{rd} Generation (3G) cellular communication network, a 3^{rd} Generation Long Term Evolution (LTE) network, or a 4^{th} Generation (4G) cellular communication network.

One or more processors included in the one or more computing systems that make up a component health monitoring system in accordance with various disclosed implementations may embody any general-purpose or special-purpose computer microprocessor configured to execute computer program instructions, applications, or programs stored in a main memory and/or in an onboard or external storage device. Various memory modules may include, for example, a random access memory (RAM) or other type of dynamic or volatile storage device or non-transitory, computer-readable medium.

The optical system of the component health monitoring system may embody any image-detection device mounted to or otherwise associated with the machine 10, another machine, an offboard imaging station, or a mobile device that captures a digital image of an area that includes a work implement of the machine and one or more components mounted on the implement. The optical system may be configured to irradiate the desired area of the machine in a variety of different translational and rotational positions of the machine. The component health monitoring system may also include one or more sensors configured to capture target images of the desired area and communicate the target images to an image processor that is onboard the machine or offboard at one or more locations.

The image processor may be configured to receive the target images from the one or more sensors and analyze the target images. Analysis of the target images may include determining a feature set that characterizes the target image. The image processor may also be configured to retrieve a reference image from a memory. The reference image may include an image of the work implement with the component mounted on the work implement and having dimensions that fall within acceptable thresholds. If desired, a reference image may also include an image of the work implement with one or more components such as GET's missing from the work implement, or an image of the work implement with a component mounted on the work implement and having dimensions that fall outside of acceptable thresholds. A library of these reference images may be pre-recorded and stored in one or more memories, onboard a machine, or offboard at a back office or other locations. The reference images may be obtained under a variety of different lighting conditions, environmental conditions, translational positions of the machine, or rotational positions or orientations of the machine. The library may be continually updated as new models of machines and new components are developed and placed into service under a large variety of different circumstances and operating conditions.

The image processor may also be configured to build and train a model for use by a classifier that segregates feature sets determined from a plurality of target images into a first classification that includes features that characterize a portion of an image including the component with dimensions that fall within acceptable thresholds. The classifier may also segregate feature sets determined from a plurality of target images into a second classification that includes features that characterize one of a portion of the image including the component with dimensions that fall outside of the acceptable threshold, or the component missing entirely from the portion of the image. Examples of the types of features that may be extracted by the image processor from target images and from reference images may include directional changes in image intensity for one or more localized cells that each contain a plurality of pixels of the image; edges, or points where there is a boundary between two image regions; corners or other interest points on the image; blobs or regions of interest; and ridges, such as may be present in an image of an elongated object along an axis of symmetry. Feature detection may provide attributes for localized cells that each contain a plurality of pixels of the image. These attributes may include edge orientation, directional changes in image intensity, gradient magnitude in edge detection, and the polarity and the strength of a blob in blob detection.

The component health monitoring system in accordance with various implementations of this disclosure may also include a notification module. The notification module may be configured to notify an operator of the machine or other personnel or parties when the image processor classifies a new target image as falling within a classification indicating a component is missing from a work implement of the machine, or is worn beyond acceptable threshold dimensions.

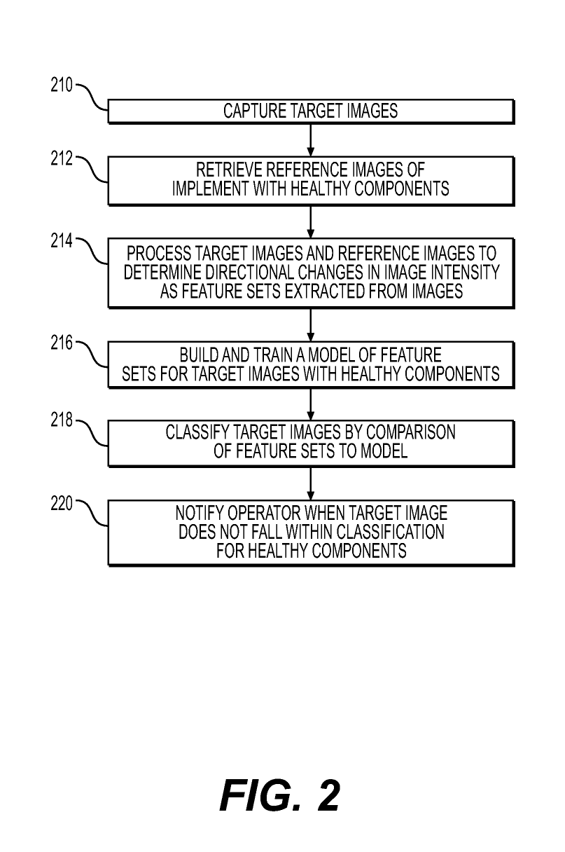

An exemplary process that may be performed by a component health monitoring system in accordance with this disclosure is illustrated in FIG. 2, and will be described in detail in the following section.

### INDUSTRIAL APPLICABILITY

The disclosed component health monitoring system may be used with any machine having a ground engaging tool (GET) or other component subjected to wear, breakage, or disconnection from the machine or a work implement on the machine. The disclosed component health monitoring system may determine whether the component has worn below acceptable threshold dimensions, or whether the component is completely missing from the machine. The component health monitoring system may also determine an amount of useful life remaining in a GET, and/or a wear rate of the GET. The disclosed system may display notifications to a machine operator regarding the monitored parameters for various components and/or communicate the notifications to an offboard entity. The notifications may be generated continuously or, alternatively, only after a comparison with one or more threshold values indicates the need to generate the notification (e.g., only when the remaining useful life and/or current dimensions of the component are less than a threshold life or dimensions, or when the component is missing.)

In step 210 of FIG. 2, an optical system may capture a target image of a component mounted on a work implement of machine 10. In some alternative embodiments, an operator of machine 10, or other personnel at a work site where machine 10 is being used may have a concern that a component such as GET 24 of machine 10 is worn beyond acceptable thresholds, or is missing entirely. The operator or other personnel may select and launch a component health monitoring procedure in accordance with various implementations of this disclosure by pressing a button or other input device on a display panel within the cab 18. In various alternative implementations of this disclosure the component health monitoring procedure may occur on a continuous or periodic basis without requiring initiation by an operator or other personnel. In additional or alternative embodiments, the operator or other personnel may initiate the component health monitoring process from a mobile device, such as a smartphone, tablet, or laptop computer, that is separate from the machine, or the process may be initiated by a third party at a back office or other offboard location. Various cameras or other devices and image sensors may be oriented in order to obtain a target image of the work implement and component, or the machine may be moved to a position within the field of view of one or more cameras or other image sensors that are associated with the component health monitoring system. The image sensors may include light-sensitive cameras, range sensors, tomography devices, radar, infrared cameras, ultra-sonic cameras, and other devices that use one or more of a variety of different forms of radiation in order to detect features of a component being monitored. The target image captured at step 210 may be communicated to an image processor that is part of the component health monitoring system, either onboard the machine, or at one or more offboard locations. Communication of the target image may occur over a wired or wireless interface.

At step 212, the image processor may retrieve reference images of the work implement with healthy components having locations and dimensions that fall within acceptable limits. The reference images may have been pre-recorded and stored in one or more memories. The reference images may be retrieved from the one or more memories onboard or offboard the machine. The reference images may include images taken in a variety of different lighting conditions, environmental conditions, translational positions of the machine, rotational positions and orientations of the machine, and machine operating conditions in order to provide data for a robust model to be used in classifying new target images that may be obtained under many different conditions. At step 214, the image processor may process the target images and the reference images to identify feature sets associated with each of the images. In one implementation, as shown in step 214, the image processor may determine directional changes in image intensity as at least some of the features extracted from the images. However, a variety of different techniques may be used for feature detection on the target and reference images.

Some examples of the types of image features that may be detected by the component health monitoring system according to implementations of this disclosure may include edges, or points where there is a boundary between two image regions, corners or other interest points on the image, blobs or regions of interest, and ridges, such as may be present in an image of an elongated object along an axis of symmetry. Feature detection may provide attributes for localized cells that each contain a plurality of pixels of the image. These attributes may include edge orientation, directional changes in image intensity, gradient magnitude in edge detection, and the polarity and the strength of a blob in blob detection. The extraction of feature sets from the images by the image processor may be performed after some preliminary processing of the image data, including filtering to remove data outliers and reduce noise, contrast enhancement, and other normalization procedures to ensure that relevant information can be detected. Various techniques employed for extraction of feature sets from the images may include the use of Harris Corner Detector procedures, neural networks, and histogram of oriented gradients (HOG). HOG is a feature descriptor used in computer vision and image processing for the purpose of object detection. In particular, the technique in accordance with various implementations of this disclosure may count occurrences of gradient orientation in localized portions of an image that includes one or more GET 24 mounted on a work implement 22. The method is similar to edge orientation histograms, but differs in that the HOG technique is performed on a dense grid of uniformly spaced cells or groups of pixels in the image, and uses overlapping local contrast normalization for improved accuracy. The HOG technique attempts to describe local object appearance and shape within an image by the distribution of intensity gradients or edge directions. The distribution of intensity gradients and edge directions for an image of a healthy component mounted on a work implement may be distinguished by the image processor from a distribution of intensity gradients and edge directions for a component that has dimensions outside of acceptable thresholds, or for an area on a work implement where the component is missing. The extracted feature sets from reference images taken of various work implements or other portions of the machines with healthy components, components that do not have dimensions within acceptable thresholds, or missing components may be stored in one or more memories or libraries of feature sets.

After the extraction of feature sets from the reference images at step 214, the image processor may build and train a model of feature sets for use in identifying target images that include healthy components at step 216. The model may be a supervised learning model with associated learning algorithms that analyze data and recognize patterns, and use this information to classify images as containing healthy components, containing components that are in need of replacement or repair, or identifying an area where a component is missing. As part of the process of building and training a model of feature sets, a user may determine what types of training examples will be used as a training set. Alternatively or in addition, a processor may be configured to perform this selection process based on empirical data or historical data relevant to different types of GET's, and expected wear characteristics of certain GET's on different types of work implements and machines. The training set may comprise reference images taken of the GET's or other components to be monitored in their proper, mounted positions on work implements or other portions of a machine. The images may be taken with the machine in various translational and rotational positions, and under different lighting and environmental conditions. The training sets are chosen as representative of the real-world use of the machine, and the feature sets for the training sets are characteristic of images reflecting the conditions that will likely be experienced during use of the component health monitoring system.

In step 218, the trained model is able to classify new target images as falling within one of two classifications by comparing the feature set extracted from each new target image to the feature sets of the model. One possible example of a classifier that may be used to perform step 218 is a support vector machine (SVM). The SVM is a supervised learning model with associated learning algorithms that assigns the new feature sets extracted from new target images into one category or another. For example, when determining whether a new target image includes a work implement with components that are being monitored, the SVM may map the extracted feature set from the new target image into a classification that includes the work implement or into another classification that does not include the work implement. For feature sets from target images including the work implement, the SVM may further classify each new target image into a first classification that includes features that characterize a portion of an image including the component with dimensions that fall within acceptable thresholds, or into a second classification that includes features that characterize one of a portion of the image including the component with dimensions that fall outside of the acceptable thresholds or the component missing entirely from the portion of the image.

In step 220, the component health monitoring system may provide a notification to an operator or other personnel when a target image does not fall within the classification of feature sets characterizing healthy components.

The component health monitoring system and included image processor in accordance with various implementations of this disclosure may embody a single microprocessor or multiple microprocessors that perform the steps described above. Numerous commercially available microprocessors can be configured to perform the functions of the described image processor. It should be appreciated that the image processor could readily be embodied in a general machine microprocessor capable of controlling numerous machine functions. The component health monitoring system may include a memory, a secondary storage device, one or more processors, and any other components and/or software modules for running an application and/or recording signals from various sensors. Various other circuits may be associated with the system, such as power supply circuitry, signal conditioning circuitry, solenoid driver circuitry, and other types of circuitry.

One or more libraries of feature sets characteristic of reference images that include the component to be monitored mounted in position and having dimensions within acceptable limits may be stored in one or more memories of the component health monitoring system. Each of these libraries may include a collection of image data acquired over a period of time for a variety of machines and components being operated in a variety of different conditions. A classifier such as the SVM model may be trained and constantly improved, either in real time, or at times when the machine is idle and component monitoring is not being performed. As feature sets are extracted from more and more reference images that include components to be monitored in position on one or more machines and having dimensions within acceptable limits, the library of feature sets that are used for training the SVM model increases, and the model becomes more and more robust. As a result, the ability of the model to accurately classify new target images as either including healthy components or not, continually improves. In various embodiments the component health monitoring system may be configured to generate notifications regarding the health of components, including the rate at which components are wearing out, how much useful life for each component remains, and whether all components are present and accounted for on a work implement of a machine.

The notification generated by the component health monitoring system may be shown on a display located within operator station 18. The notification may provide a visual and/or audible alert regarding a current dimension of a GET, a remaining useful life for the GET, and/or a need to replace a cutting edge on a GET. In this manner, the operator may be able to schedule maintenance of machine 10 in advance of when a GET or cutting edge of a GET is completely worn out.

It will be apparent to those skilled in the art that various modifications and variations can be made to the component health monitoring system of the present disclosure without departing from the scope of the disclosure. Other embodiments will be apparent to those skilled in the art from consideration of the specification and practice of the monitoring system disclosed herein. It is intended that the specification and examples be considered as exemplary only, with a true scope of the disclosure being indicated by the following claims and their equivalent.

What is claimed is:

1. A component health monitoring system for use with a machine, the component health monitoring system comprising:
an optical system configured to irradiate an area containing a work implement and including a surface of a component to be inspected in a position mounted on the work implement;
a sensor configured to capture a target image of the area;
an image processor configured to receive the target image from the sensor and analyze the target image, the image processor further configured to:
determine a first feature set for the target image;
retrieve a reference image from a memory, wherein the reference image includes at least one of:
an image of the work implement with the component mounted on the work implement and having dimensions that fall within acceptable thresholds;
an image of the work implement with one or more of the component missing from the work implement; and
an image of the work implement with the component mounted on the work implement and having dimensions that fall outside of acceptable thresholds;
determine a second feature set for the reference image;
determine the first and second feature sets by determining a directional change in image intensity for one or more localized cells that each contain a plurality of pixels of the respective image; and
build and train a model for use by a classifier that segregates feature sets determined from a plurality of target images into a first classification that includes features that characterize a portion of an image including the component with dimensions that fall within acceptable thresholds, and a second classification that includes features that characterize one of:
a portion of the image including the component with dimensions that fall outside of the acceptable thresholds; or
the component missing entirely from the portion of the image; and
a notification module that notifies an operator of the machine when the image processor classifies a new target image as falling within the second classification.

2. The component health monitoring system of claim 1, wherein the image processor is configured to determine the first and second feature sets by determining a histogram of oriented gradients (HOG) for the respective images.

3. The component health monitoring system of claim 1, wherein the image processor is configured to build and train a model for use by a support vector machine (SVM).

4. The component health monitoring system of claim 3, wherein the SVM model is configured to assign new target images including a GET mounted in position on a work implement and having dimensions within acceptable thresholds into the first classification, and assign new target images including a work implement that is missing a GET or that includes a GET having dimensions outside of acceptable thresholds into the second classification.

5. The component health monitoring system of claim 1, wherein the component is a ground engagement tool (GET).

6. The component health monitoring system of claim 1, wherein the image processor is further configured to build and train the model by identifying a plurality of feature sets extracted from a plurality of reference images captured under a plurality of different lighting conditions and environmental conditions and falling within at least one of the first or second classifications.

7. The component health monitoring system of claim 1, wherein the optical system is configured to irradiate the area with visible light, and the sensor is configured to capture a target image that is a digital image in a visible light spectrum.

8. The component health monitoring system of claim 1, wherein the optical system is configured to irradiate the area with infrared light, and the sensor is configured to capture a target image that is a digital image in the infrared light spectrum.

9. The component health monitoring system of claim 1, further including a library of reference images contained within the memory, wherein the library of reference images includes a plurality of images with the component mounted on the work implement in different lighting and environmental conditions.

10. A method for monitoring the health of a component mounted on a work implement, the method comprising:
capturing target images of the work implement using an optical system and one or more sensors;
retrieving from a memory reference images of the work implement with one or more of the components having positions on the implement and dimensions within acceptable threshold values;
processing the target images and the reference images to determine directional changes in image intensity as feature sets extracted from the images;
building and training a model of expected feature sets for target images including one or more components having positions on the work implement and dimensions within acceptable thresholds;
classifying the target images by comparison of feature sets for the images to the model; and
notifying an operator of the machine when a target image does not fall within a desired classification.

11. The method of claim 10, further including retrieving from the memory an image of the work implement with one or more of the component missing from the work implement, and an image of the work implement with the component mounted on the work implement and having dimensions that fall outside of acceptable thresholds; and
determining the feature sets extracted from the images by determining a histogram of oriented gradients (HOG) for the respective images.

12. The method of claim 10, wherein building and training a model of expected feature sets for target images comprises building and training a support vector machine (SVM) model.

13. The method of claim 12, wherein the SVM model assigns new target images including a GET mounted in position on a work implement and having dimensions within acceptable thresholds into a first classification of feature sets, and assigns new target images including a work implement that is missing a GET or that includes a GET having dimensions outside of acceptable thresholds into a second classification of feature sets.

14. The method of claim 10, wherein capturing target images of the work implement includes capturing images that include at least one GET mounted on the work implement.

15. The method of claim 10, wherein building and training the model of expected feature sets for target images includes identifying a plurality of feature sets extracted from a plurality of reference images captured under a plurality of different lighting conditions and environmental conditions.

16. The method of claim 10, wherein capturing target images of the work implement using an optical system and one or more sensors includes irradiating the work implement with visible light and capturing the target image with the sensor as a digital image in a visible light spectrum.

17. The method of claim 10, wherein capturing target images of the work implement using an optical system and one or more sensors includes irradiating the work implement with infrared light, and capturing the target image with the sensor as a digital image in an infrared light spectrum.

18. A computer-readable medium for use in a component health monitoring system, the computer-readable medium comprising computer-executable instructions for performing a method with at least one image processor, wherein the method comprises:
capturing target images of a work implement using an optical system and one or more sensors;
retrieving from a memory reference images of the work implement with one or more of the components having positions on the implement and dimensions within acceptable threshold values;
processing the target images and the reference images to determine directional changes in image intensity as feature sets extracted from the images;
building and training a model of expected feature sets for target images including one or more components having positions on the work implement and dimensions within acceptable thresholds;
classifying the target images by comparison of feature sets for the images to the model; and
notifying an operator of the machine when a target image does not fall within a desired classification.

19. The computer-readable medium of claim 18, wherein the method further includes:
retrieving from the memory an image of the work implement with one or more of the component missing from the work implement, and an image of the work implement with the component mounted on the work implement and having dimensions that fall outside of acceptable thresholds; and
determining the feature sets extracted from the images by determining a histogram of oriented gradients (HOG) for the respective images.

20. The computer-readable medium of claim 18, wherein the method further includes building and training a model of expected feature sets for target images by building and training a support vector machine (SVM) model that assigns new target images including a GET mounted in position on a work implement and having dimensions within acceptable thresholds into a first classification of feature sets, and assigns new target images including a work implement that is missing a GET or that includes a GET having dimensions outside of acceptable thresholds into a second classification of feature sets.
